(19) United States
(12) Patent Application Publication
(10) Pub. No.: US 2008/0193665 A1
(43) Pub. Date: Aug. 14, 2008

(54) Two-constituent photo curable ink set, method for manufacturing optical element, and optical element

(75) Inventors: Takashi Oyanagi, Shiojiri-shi (JP); Keitaro Nakano, Matsumoto-shi (JP); Yoshihiro Terada, Azumino-shi (JP)

Correspondence Address: Ladas & Parry, 26 West 61st Street, New York, NY, 10023-7604, US

(73) Assignee: SEIKO EPSON CORPORATION

(21) Appl. No.: 11/901,083

(22) Filed: Sep. 14, 2007

(30) Foreign Application Priority Data
Sep. 15, 2006 (JP) 2006-251585
Jul. 31, 2007 (JP) 2007-198884

(51) Int. Cl. C08J 7/06; C08F 2/50

(52) U.S. Cl. 427/511; 522/39; 427/162

(57) ABSTRACT

A two-constituent photo curable ink set, comprising: an ink composition A that includes a pigment and a polymerizable compound; and an ink composition B that includes a pigment and a polymerizable compound, wherein the ink composition A and the ink composition B are mixed and then photoset by being irradiated with light.

The entire disclosure of Japanese Patent Application Nos. 2006-285096, filed on Oct. 19, 2006, and 2006-285102, filed on Oct. 19, 2006, are expressly incorporated by reference herein.

### BACKGROUND

1. Technical Field

The present invention relates to a two-constituent photo curable ink set that is mixed and then photo curing by irradiation with light or ultraviolet ray.

2. Related Art

Projectors are used for presentations during meetings, home theater systems, and other such applications. Using a projector improves the visibility of an image by projecting it onto a large screen, giving the viewers a more realistic experience. Such projectors are equipped with an optical device for producing an optical image corresponding to an image signal.

To prevent light leakage, a light blocking layer is formed in the optical device by coating a substrate surface, such as an end face of a translucent substrate, with a black, oil-based ink by hand, using a brush or a felt-tip pen.

However, it is difficult to form a uniform film by hand coating at an accurate position within a predetermined range, and variance in light blocking performance is produced by coating unevenness or bleeding of the ink. Plus, repairing this entailed considerable work.

Also, the optical density (OD) of the light blocking layer is not adequate with hand coating.

Meanwhile, a light blocking layer can also be formed by coating a substrate surface with a water-based ink composition. In general, when a fabric or a type of paper that is not readily penetrated by a water-based ink composition, such as coated paper or printing stock, or a metal, plastic, or other such material that is not penetrated at all, such as a sheet manufactured from phenol, melamine, vinyl chloride, acrylic, polycarbonate, or another such resin, is coated, the ink composition needs to contain a component that can be stably fixed to the substrate.

A photo curable ink containing a colorant, a polymerizable compounds, a photo (polymerization) initiator, and so forth has been disclosed as a way to meet this need (see the Specification of U.S. Pat. No. 5,623,001, for example). With this photo curable ink, it is said that the ink is prevented from bleeding onto the substrate and image quality is improved.

Nevertheless, when the above-mentioned photo curable ink composition is used, a problem is the insufficient OD value of the light blocking layer. To obtain a higher OD value, the pigment concentration has to be raised or the coating thickness increased, but both of these end up raising the amount of energy required for curing. Furthermore, if the dose of ultraviolet rays is too high, the generated heat may damage the workpiece, producing a defective product.

It is also possible to form a light blocking layer by coating with an ink composition that includes an organic solvent or water, which are volatile substances that do not participate in the curing reaction, but in this case not only is VOC generation undesirable, but heat can produce bubbles, or bleed-out from the cured product can result in tackiness, or the coating can ooze out from the workpiece and cause separation.

### SUMMARY

In view of this, an advantage of some aspects of the invention is that the above-mentioned problems are solved and there are provided a two-constituent photo curable ink set that suppresses coating unevenness and allows a coating film with excellent mechanical strength and good adhesion to be formed on a substrate, and a method for manufacturing an optical element, and an optical element, in which this ink set is used.

The inventors arrived at the present invention upon discovering that the above-mentioned advantage can be achieved by employing the following constitution.

Specifically, the present invention provides:

(1) A two-constituent photo curable ink set, having an ink composition A that includes a pigment and a polymerizable compound, and an ink composition B that includes a pigment and a polymerizable compound, wherein the ink composition A and the ink composition B are mixed and then photoset by being irradiated with light.

(2) The two-constituent photo curable ink set according to (1) above, wherein the pigment concentration Ca in the ink composition A and the pigment concentration Cb in the ink composition B satisfy the relation Ca<Cb.

(3) The two-constituent photo curable ink set according to (1) or (2) above, wherein the ink composition A and/or the ink composition B includes at least one type of optical radical polymerization initiator.

(4) The two-constituent photo curable ink set according to (3) above, wherein the optical radical polymerization initiator is one or more of α-aminoketone, α-hydroxyketone, and acylphosphine oxide.

(5) The two-constituent photo curable ink set according to any of (1) to (4) above, wherein the ink composition A and/or the ink composition B includes ethylene glycol monoallyl ether and/or N-vinylformamide as a polymerizable compound.

(6) The two-constituent photo curable ink set according to any of (1) to (4) above, wherein the ink composition A and/or the ink composition B includes at least one type of dendritic polymer as a polymerizable compound.

(7) The two-constituent photo curable ink set according to (6) above, wherein the dendritic polymer is a hyperbranched polymer.

(8) The two-constituent photo curable ink set according to any of (1) to (7) above, wherein the ink composition A and/or the ink composition B includes at least one type of surfactant.

(9) The two-constituent photo curable ink set according to (8) above, wherein the surfactant is a polyether-modified polydimethylsiloxane or a polyester-modified polydimethylsiloxane.

(10) The two-constituent photo curable ink set according to any of (1) to (9) above, wherein the ink composition A and/or the ink composition B includes at least one type of amine-based polymerization accelerator.

(11) The two-constituent photo curable ink set according to any of (1) to (10) above, wherein the ink composition A and/or the ink composition B includes at least one type of HALS-based radical polymerization inhibitor.

(12) The two-constituent photo curable ink set according to any of (1) to (11) above, wherein the ink composition A and/or the ink composition B includes at least one type of thioxanthone-based sensitizer.

(13) The two-constituent photo curable ink set according to any of (1) to (12) above, wherein the ink composition A and/or the ink composition B includes a black pigment as a pigment.

(14) The two-constituent photo curable ink set according to (13) above, wherein the black pigment is carbon black.

(15) The two-constituent photo curable ink set according to any of (1) to (14) above, wherein neither the ink composition A nor the ink composition B includes a volatile component.

(16) A method for manufacturing an optical element, which includes producing an optical element by inkjet process using the two-constituent photo curable ink set according to any of (1) to (15) above.

(17) A method for manufacturing an optical element, which includes producing an optical element by screen printing, flexographic printing, or pad printing using the two-constituent photo curable ink set according to any of (1) to (15) above.

(18) A method for manufacturing an optical element, which includes forming a light-blocking film pattern by inkjet process using the two-constituent photo curable ink set according to any of (1) to (15) above, and then conducting a curing reaction by irradiation with ultraviolet rays.

(19) The method for manufacturing an optical element according to (18) above, wherein the irradiation with ultraviolet rays is performed using an LED and/or LD as an ultraviolet ray source.

(20) The method for manufacturing an optical element according to (18) above, wherein the irradiation with ultraviolet rays is performed using an LED array formed of a plurality of semiconductor elements having different wavelength peaks.

(21) An optical element, manufactured by the manufacturing method according to any of (16) to (20) above.

(22) An optical element for a projector, manufactured by the manufacturing method according to any of (16) to (20) above.

### BRIEF DESCRIPTION OF THE DRAWINGS

FIG. 1 is an oblique view of a synthetic optical component in a step of assembling an optical device.

### DESCRIPTION OF EXEMPLARY EMBODIMENTS

The present invention provides a two-constituent photo curable ink set that suppresses coating unevenness and allows a coating film with excellent mechanical strength and good adhesion to be formed on a substrate, and a method for manufacturing an optical element, and an optical element, in which this ink set is used.

Embodiments of the present invention will now be described. The following embodiments are merely examples used to describe the present invention, and the present invention should not be construed as being limited to these embodiments alone. The present invention can be worked in many different aspects without departing from the gist thereof.

The two-constituent photo curable ink set of the present invention has an ink composition A that includes a pigment and a polymerizable compound, and an ink composition B that includes a pigment and a polymerizable compound, wherein the ink composition A and the ink composition B are mixed and then photoset by being irradiated with light.

Using this two-constituent photo curable ink set suppresses coating unevenness and allows a coating film with excellent mechanical strength and good adhesion to be formed on a substrate.

The ink composition A and the ink composition B are mixed and then photoset by being irradiated with light. With the present invention, the ink compositions A and B may be applied to the same location on the substrate, mixed on the substrate, and then photoset by being irradiated with light. Alternatively, after the ink compositions A and B are mixed, they may be applied to a substrate in a mixed state and then photoset by being irradiated with light.

It is preferable if the pigment concentration Ca in the ink composition A and the pigment concentration Cb in the ink composition B satisfy the relation Ca<Cb.

The pigment concentration Ca in the ink composition A and the pigment concentration Cb in the ink composition B are preferably each within a range of about 0.1 to 25 wt %, and more preferably within a range of about 0.5 to 15 wt %.

It is preferable if the ink composition A and/or the ink composition B includes at least one type of optical radical polymerization initiator.

There are no particular restrictions on the above-mentioned optical radical polymerization initiator, but α-aminoketone, α-hydroxyketone, and acylphosphine oxide are preferable, examples of which include α-hydroxyalkylphenone, α-aminoalkylphenone, monoacylphosphine oxide, and bisacylphosphine oxide.

Optical radical polymerization initiators available under the trade names of Irgacure 127, 184, 2959, 369, 379, 907, 1700, 1800, 1850, 1870, 819, and 4265, Darocur 1173, and TPO (made by Chiba Specialty Chemicals) can also be used.

The ink composition A and/or the ink composition B preferably contain as a polymerizable compound an allyl compound, and more preferably an allyl ether compound, ethylene glycol monoallyl ether, trimethylolpropane diallyl ether, trimethylolpropane monoallyl ether, glycerol monoallyl ether, allyl glycidyl ether, or pentaerythritol triallyl ether, with ethylene glycol monoallyl ether, trimethylolpropane diallyl ether, and/or an N-vinyl compound being particularly favorable, and N-vinylformamide being especially good.

Ethylene glycol monoallyl ether and/or the N-vinylformamide is a monofunctional radical polymerizable monomer, which is favorable in usage because undesirable polymerization is not caused by dark reaction during storage. In particular, a characteristic of ethylene glycol monoallyl ether, trimethylolpropane diallyl ether, and other such allyl ether compounds is that they will not polymerize by themselves, even in the presence of carbon radicals produced by the decomposition of the optical radical polymerization initiator.

The amount in which the ethylene glycol monoallyl ether and/or N-vinylformamide is added to the ink composition is preferably 20 to 80 wt %. Problems with the viscosity, dispersion stability, storage stability, and so forth of the ink composition will be encountered below 20 wt %, but if the amount is over 80 wt %, the curability and film strength may be inadequate for the two-constituent photo curable ink composition. A preferable range is 20 to 70 wt %.

It is also preferable if the ink composition A and/or the ink composition B includes at least one type of dendritic polymer as a polymerizable compound.

Examples of dendritic polymers include (I) dendrimers, (II) linear dendritic polymers, (III) dendritic graft polymers, (IV) hyperbranched polymer, (V) star hyperbranched polymers, and (VI) hypergrafted polymers.

Of these, (I) to (III) have a degree of branching (DB) of 1 and a structure that is free of defects, while (IV) to (VI) have a random branched structure that may include defects.

The amount in which the dendritic polymer is added to the ink composition A or B is preferably within a range of about 3 to 30 wt %, so as to maintain the suitability of the composition as a two-constituent photo curable ink composition set. A more preferable range is about 5 to 25 wt %. If the amount in which the dendritic polymer is added is less than 3 wt %, the curability of the two-constituent photo curable ink composition set will be inadequate, but if 30 wt % is exceeded, problems with the viscosity, dispersion stability, storage stability, and so forth of the ink composition may be encountered.

The above-mentioned dendritic polymer is preferably a hyperbranched polymer. A hyperbranched polymer is highly branched, with a three-dimensionally branching structure, so the viscosity of the ink can be kept lower than with a linear polymer of the same molecular weight.

With the present invention, a single type of dendritic polymer may be used alone, or different types of dendritic polymer may be used together.

It is preferable if the hyperbranched polymer is a solid at room temperature and has a number average molecular weight of 1000 to 100,000, with a range of 2000 to 50,000 being particularly favorable. If the molecular weight is below the above range, the fixed image will be brittle, but if the molecular weight is above this range, the viscosity of the ink will be too high even if the added amount is reduced, making this impractical in terms of discharge characteristics.

It is also preferable if the hyperbranched polymer has a radical polymerizable functional group on its outermost surface. Employing a radical polymerizable structure on the outermost surface allows the polymerization reaction to proceed faster.

A hyperbranched polyethylene glycol can be used, for example, as the hyperbranched polymer. A hyperbranched polymer is obtained by using a monomer having per molecule two or more types of reaction point corresponding to a branch portion, and just one different type of reaction point corresponding to a linking portion, and synthesizing the targeted polymer in a single stage (Macromolecules, Vol. 29 (1996), pp. 3831-3838). A 3,5-dihydroxybenzoic acid derivative is an example of a monomer that can be used for a hyperbranched polymer. An example of a method for manufacturing a hyperbranched polymer is to heat methyl 3,5-bis((8′-hydroxy-3′,6′-dioxaoctyl)oxy)benzoate (which is a hydrolyzate of methyl 3,5-bis((8′-(t-butyldiphenylsiloxy)-3′,6′-dioxaoctyl)oxy)benzoate obtained from 1-bromo-8-(t-butyldiphenylsiloxy)-3,6-dioxaoctane and methyl 3,5-dihydroxybenzoate) along with dibutyltin diacetate under a nitrogen atmosphere, and thereby synthesize a poly[bis(triethylene glycol) benzoate] that is a hyperbranched polymer.

When 3,5-dihydroxybenzoic acid is used, the hyperbranched polymer terminal groups are hydroxyl groups, so hyperbranched polymers having various kinds of terminal group can be synthesized by using alkyl halides that are suitable for these hydroxyl groups.

The characteristics of a hyperbranched polymer are governed by the chemical structure of the main chain and by the chemical structure of the terminal groups thereof, and these characteristics will vary greatly depending on the terminal groups or the substituents in the chemical structure. A polymer having polymerizable groups at its terminals is particularly useful because its greater reactivity affords a better gelling effect after an optical reaction.

With the present invention, a single type of hyperbranched polymer may be used alone, or different types of hyperbranched polymer may be used together.

The ink composition A and/or the ink composition B may further contain another polymerizable compound.

There are no particular restrictions on the other polymerizable compound that may be contained by the ink composition A and/or the ink composition B, but an example is a monomer.

The term monomer refers to a molecule that can serve as the structural units in the basic structure of a macromolecule. The monomer used in the present invention is also called a photopolymerizable monomer, and includes monofunctional monomers, difunctional monomers, and polyfunctional monomers, all of which can be used. With all of these monomers, the primary irritation index (PII) is preferably 2 or less.

Furthermore, the ink composition A and/or the ink composition B may contain an oligomer in addition to the above-mentioned monomer as another polymerizable compound.

The ink composition A and/or the ink composition B may contain at least one type of surfactant.

This surfactant is preferably a polyester-modified silicone, a polyether-modified silicone, a polyether-modified polydimethylsiloxane, a polyester-modified polydimethylsiloxane, or the like. A polyether-modified polydimethylsiloxane or polyester-modified polydimethylsiloxane is particularly favorable.

Specific examples include BYK-347, BYK-348, BYK-UV3500, 3510, 3530, and 3570 (made by BYK-Chemie Japan).

The ink composition A and/or the ink composition B may include at least one type of amine-based polymerization accelerator.

Examples of amine-based polymerization accelerators include Darocur EHA and EDB which is aminobenzoate (made by Chiba Specialty Chemicals).

The ink composition A and/or the ink composition B may contain at least one type of thermal radical polymerization initiator in order to improve the storage stability of the ink composition.

Hindered phenol compounds and HALS-based compounds are thermal radical polymerization initiators, and an example of a hindered phenol compound is Irgastab UV-22, while an example of a HALS-based compound is Irgastab UV-10 (made by Chiba Specialty Chemicals).

The ink composition A and/or the ink composition B may contain at least one type of thioxanthone-based sensitizer.

Examples of thioxanthone-based sensitizers include isopropylthioxanthone, diethylthioxanthone, and chlorothioxanthone. Products marketed under the trade names of Darocur ITX (made by Chiba Specialty Chemicals) and Kayacure DETX-S (made by Nippon Kayaku Co., Ltd.) can also be used.

The ink composition A and/or the ink composition B preferably includes a black pigment as a pigment. The black pigment is preferably carbon black.

This allows a light blocking film with excellent black color expression to be formed during formation on a substrate.

Examples of carbon black include C.I. Pigment Black 7; No. 2300, No. 900, MCF88, No. 33, No. 40, No. 45, No. 52, MA7, MA8, MA100, No. 2200B, and so forth made by Mitsubishi Chemicals; Raven 5750, 5250, 5000, 3500, 1255, 700, and so forth made by Columbia; Regal 400R, 330R, and 660R, Mogul L and 700, Monarch 800, 880, 900, 1000, 1100, 1300, and 1400, and so forth made by Cabot; Color Black FW1, FW2, FW2V, FW18, and FW200, Color Black S150, S160, and S170, Printex 35, U, V, and 140U, Special Black 6, 5, 4A, and 4, and so forth made by Degussa.

The above-mentioned pigment can be used for the ink composition A or the ink composition B in the form of a pigment dispersion obtained by dispersing a pigment in an aqueous medium with a dispersant or a surfactant.

A preferable dispersant is one that is commonly used to prepare pigment dispersions, such as a macromolecular dispersant.

If needed, a leveling additive, matting agent, or, to adjust the film properties, a polyester resin, polyurethane resin, vinyl resin, acrylic resin, rubber resin, polyacrylpolyol resin, polyoxyalkylene polyalkyleneamine resin, or wax can be added to the ink compositions A and B. Also, a humectant, penetrating solvent, pH regulator, preservative, anti-mildew agent, or the like can be added to the ink composition A or B of the present invention as other known components that can be used in two-constituent photo curable inks.

It is preferable if the ink composition A and the ink composition B both contain a volatile component.

This constitution prevents separation, tackiness, and so forth caused by bleed-out from the cured product, the generation of VOC, and bubbles produced by heat.

With the method for manufacturing an optical element of the present invention, the above-mentioned two-constituent photo curable ink set is used to produce an optical element by inkjet process.

Also, with the method for manufacturing an optical element of the present invention, the above-mentioned two-constituent photo curable ink set is used to produce an optical element by screen printing, flexographic printing, or pad printing.

Also, with the method for manufacturing an optical element of the present invention, the above-mentioned two-constituent photo curable ink set is used to form a light-blocking film pattern by inkjet process, and then a curing reaction is conducted by irradiation with ultraviolet rays.

The dose of ultraviolet rays is at least 10 mJ/cm² and no more than 20,000 mJ/cm², and preferably at least 50 mJ/cm² and no more than 15,000 mJ/cm². A sufficient curing reaction can be conducted if the ultraviolet ray dose is within about this range.

Examples of [sources for] ultraviolet irradiation include a metal halide lamp, xenon lamp, carbon arc lamp, chemical lamp, low pressure mercury vapor lamp, high pressure mercury vapor lamp, and other such lamps. For example, a commercially available source such as an H lamp, D lamp, or V lamp made by Fusion System can be used.

Ultraviolet irradiation can also be accomplished by using an ultraviolet ray light emitting diode (UV LED), an ultraviolet ray light emitting semiconductor laser, or other such an ultraviolet ray light emitting semiconductor element.

The ultraviolet ray source is preferably ultraviolet irradiation using an LED and/or LD.

Alternatively, with the above-mentioned method for manufacturing an optical element, it is preferable for the ultraviolet irradiation to be performed using an LED array composed of a plurality of semiconductor elements having different wavelength peaks.

Using a multi-wavelength LED array that emits little heat and affords high light emission for the ultraviolet ray source prevents the workpiece from being thermally damaged.

Specifically, with conventional ultraviolet ray sources such as a xenon lamp, a halogen lamp, or a low-, high-, or ultrahigh-pressure mercury vapor lamp, the emission spectrum is wide, extending from near 250 nm to visible light and infrared rays, which is good for curing an ink composition, but at the same time there are wavelengths present which are undesirable or which are not necessary for curing. Consequently, wavelengths other than those that are necessary have to be treated with an optical filter, cold mirror, cooling device, or the like, which means that more equipment is required, and this is contrary to the goals of reducing size and power consumption. Also, with a single semiconductor element, the emission spectrum is too narrow, and depending on the type of pigment, the UV absorption spectrum of the pigment itself may overlap the emission spectrum of the element, resulting in poor curing. In view of this, more efficient ultraviolet irradiation can be performed by combining a plurality of types of semiconductor element with different emission spectrum peaks, resulting in ultraviolet rays with a continuous spectrum (including part of the visible spectrum, multiwavelength).

The optical element of the present invention is manufactured by the above-mentioned manufacturing method.

The optical element for a projector of the present invention is also manufactured by the above-mentioned manufacturing method.

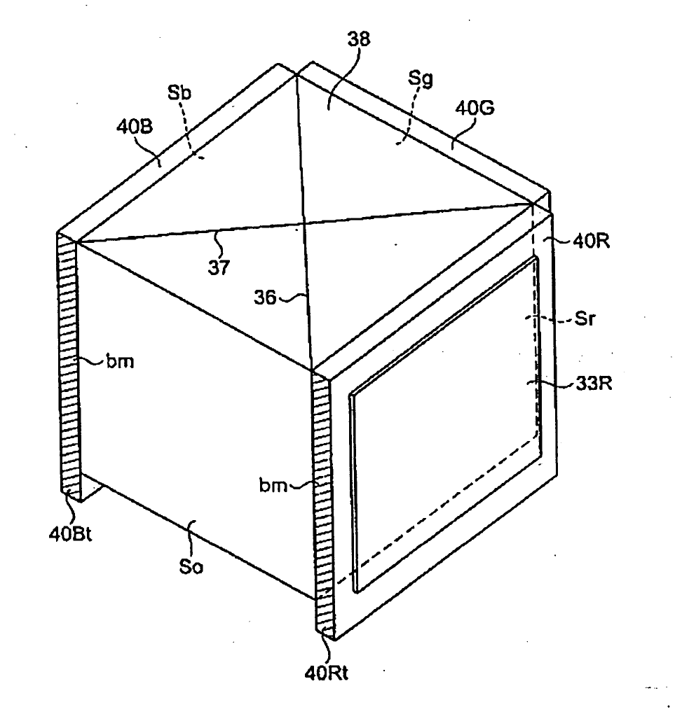

The method for forming a light blocking layer will now be described in more specific terms. FIG. 1 is an oblique view of a synthetic optical component in a step of assembling an optical device.

As shown in FIG. 1, in a step of assembling an optical device 30, the formation of a light blocking layer bm on end faces 40Rt and 40Bt is carried out at an assembly preparation work stage in which translucent substrates 40R, 40G, and 40B are bonded and fixed to dichroic films 37 and 36 that create a cross dichroic prism 38 that is a synthetic optical component. Exit-side polarizing plates 33R, 33G, and 33B have already been affixed to the translucent substrates 40R, 40G, and 40B, and these translucent substrates are bonded and fixed by an adhesive containing a solvent to incidence faces Sr, Sg, and Sb corresponding thereto.

There are microscopic steps or distortions at the end faces 40Rt and 40Bt in the thickness direction of the translucent substrates 40R and 40B, which have been formed by cleavage, cutting, or other such working. This is because these end faces are cleaved faces, or even if they have been cut, they are not mirror surfaces and have a cross section like that of ground glass.

In the step of forming the light blocking layer bm, the ink composition A and the ink composition B are applied by inkjetting to the end faces 40Rt and 40Bt of the translucent substrates 40R and 40B, and these compositions are mixed on the end faces 40Rt and 40Bt, after which they are photoset by being irradiated with light.

The ink discharge apparatus here is equipped, for example, with independent ink tanks and ink discharge heads for the ink compositions A and B, and after the ink composition A is printed to the end faces 40Rt and 40Bt, the ink composition B is then continuously printed. This results in the ink compositions A and B being mixed at the end faces 40Rt and 40Bt.

Next, the mixture of the ink compositions A and B is photoset by being irradiated with ultraviolet rays from an ultraviolet ray irradiation device, which gives the light blocking layer bm. The ultraviolet ray irradiation device may, for example, be capable of emitting ultraviolet rays in a wavelength band of 200 to 450 nm, and a device that gives an irradiation intensity in a wavelength band centered around 365 nm is particularly favorable.

### Working Examples

The present invention will now be described in further detail through working examples, but the present invention is not limited to or by these examples. A person skilled in the art will be able to make various modifications in addition to the working examples given below, and such modifications are encompassed by the Claims herein.

With the present invention, Viscoat #1000 and STAR-501, made by Osaka Organic Chemical Industry, were used as hyperbranched polymers. Viscoat #1000 and STAR-501 are hyperbranched polymers in which dipentaerythritol serves as a core from which functional groups branch off. Viscoat #1000 contains ethylene glycol diacrylate as a dilution monomer and has a viscosity of 273 mPa·s and a functional group count of 14 (acryl groups), while STAR-501 contains dipentaerythritol hexaacrylate as a dilution monomer and has a viscosity of 210 Pa·s and a functional group count of 20 to 99 (acryl groups). Both have acryloyl groups on their outermost surface, and can be used to advantage.

Also, because of its high steric regularity, a dendrimer requires numerous manufacturing steps and is very costly, whereas the steric regularity of a hyperbranched polymer is not that high, so such a polymer can be synthesized relatively easily and is therefore advantageous in terms of cost.

### Preparation of Ink Composition

### Preparation of Black Ink Composition 1

15 parts C.I. pigment black 7 (as a pigment), 5 parts Discol N-518 (made by Dai-Ichi Kogyo Seiyaku; as a dispersant), and 80 parts ethylene glycol monoallyl ether (made by Nippon Nyukazai; hereinafter abbreviated as AG; as a monomer) were stirred to produce a mixture. This mixture was put in a sand mill (made by Yasukawa Seisakusho) and dispersed with zirconia beads (1.5 mm diameter) for 6 hours. After this, the zirconia beads were separated with a separator to obtain a black pigment dispersion.

Then, the solvent and various additives listed below were admixed and completely dissolved to produce an ink solution, after which the above-mentioned black pigment dispersion was stirred while being added dropwise to the ink solution. Upon completion of the dropping, the system was stirred for 30 minutes at normal temperature.

After this the system was filtered through a 5 μm membrane filter, which gave a black ink composition 1 composed of the following components.

C.I. pigment black 7 (pigment): 3.0 wt %

polyoxyalkylene-added polyalkyleneamine (dispersant; Discol N-518 made by Dai-Ichi Kogyo Seiyaku): 1.0 wt %

N-vinylformamide (made by Arakawa Chemical Industry): 25.0 wt %

AG (made by Nippon Nyukazai): 49.6 wt %

hyperbranched polymer (STAR-501 made by Osaka Organic Chemical Industry): 12.0 wt %

BYK-UV3570 (polyester-modified silicone-based surfactant made by BYK-Chemie Japan): 0.2 wt %

Irgacure 819 (made by Chiba Specialty Chemicals): 6.4 wt %

Irgacure 369 (made by Chiba Specialty Chemicals): 1.6 wt %

Darocur EDB (made by Chiba Specialty Chemicals): 1.0 wt %

Irgastab UV-10 (made by Chiba Specialty Chemicals): 0.2 wt %

The STAR-501 used as the hyperbranched polymer is a hyperbranched polymer in which functional groups branch off from a dipentaerythritol core, contains dipentaerythritol hexaacrylate as a dilution monomer, and has a viscosity of 210 Pa·s and a functional group count of 20 to 99 (acryl groups).

The above-mentioned Irgastab UV-10 is a thermal radical polymerization initiator.

### Black Ink Composition 2

A black ink composition 2 was prepared from the following components by the same operation as for the black ink composition 1.

C.I. pigment black 7 (pigment): 9.0 wt %

polyoxyalkylene-added polyalkyleneamine (dispersant; Discol N-518 made by Dai-Ichi Kogyo Seiyaku): 3.0 wt %

N-vinylformamide (made by Arakawa Chemical Industry): 25.0 wt %

AG (made by Nippon Nyukazai): 47.6 wt %

hyperbranched polymer (made by Osaka Organic Chemical Industry): 10.0 wt %

BYK-UV3570 (polyester-modified silicone-based surfactant made by BYK-Chemie Japan): 0.2 wt %

Irgacure 819 (made by Chiba Specialty Chemicals): 6.4 wt %

Irgacure 369 (made by Chiba Specialty Chemicals): 1.6 wt %

Darocur EDB (made by Chiba Specialty Chemicals): 1.0 wt %

Irgastab UV-10 (made by Chiba Specialty Chemicals): 0.2 wt %

### Black Ink Composition 3

A black ink composition 3 was prepared from the following components by the same operation as for the black ink composition 1.

C.I. pigment black 7 (pigment): 6.0 wt %

polyoxyalkylene-added polyalkyleneamine (dispersant; Discol N-518 made by Dai-Ichi Kogyo Seiyaku): 2.0 wt %

N-vinylformamide (made by Arakawa Chemical Industry): 25.0 wt %

AG (made by Nippon Nyukazai): 47.6 wt %

hyperbranched polymer (made by Osaka Organic Chemical Industry): 10.0 wt %

BYK-UV3570 (polyester-modified silicone-based surfactant made by BYK-Chemie Japan): 0.2 wt %

Irgacure 819 (made by Chiba Specialty Chemicals): 6.4 wt %

Irgacure 369 (made by Chiba Specialty Chemicals): 1.6 wt %

Darocur EDB (made by Chiba Specialty Chemicals): 1.0 wt %

Irgastab UV-10 (made by Chiba Specialty Chemicals): 0.2 wt %

### Printing Conditions

A two-constituent photo curable ink set equipped with the above-mentioned black ink compositions 1 and 2 (Working Example 1), a two-constituent photo curable ink set equipped with the above-mentioned black ink compositions 2 and 3 (Working Example 2), and a two-constituent photo curable ink set equipped with just the black ink composition 1 (Comparative Example 1) were used to form a pattern of a light blocking film on an optical glass board with a thickness of 1.2 mm and on an SiO₂ board with a thickness of 1.4 mm, using a PM-G920 inkjet printer made by Seiko-Epson.

In Working Examples 1 and 2, the two types of ink composition were mixed and patterned on the substrate, whereas in Comparative Example 1 the black ink composition 1 was patterned by itself on the substrate.

### Curing Conditions

Light blocking film patterns were formed using a ultraviolet ray irradiation device consisting of a combination of three types of LED, namely, a Nichia i-LED “NCCU033” ultraviolet light emitting diode with a peak wavelength of 365 nm, a Nichia “NCCU001” ultraviolet light emitting diode with a peak wavelength of 380 nm (both made by Nichia Chemical Industry), and an SDN-5N3CUV-A ultraviolet light emitting diode with a peak wavelength of 395 nm (made by Sander), such that the irradiation intensity at each wavelength of 365 nm, 380 nm, and 395 nm would be 20 mW/cm², 20 mW/cm², and 20 mW/cm², respectively, for a total of 60 mW/cm², at a distance of 5 mm from the irradiation device.

The integrated irradiation dose (mJ/cm²) was found from the time it took to cure the light blocking film pattern formed on the substrate.

### Optical Density

The optical density (OD value) of the light blocking film pattern obtained as above was measured using an SPM-50 spectrophotometer (made by Gretag-MacBeth).

The results are given in Table 1.

TABLE 1

| | | | Ink | | |
|---|---|---|---|---|---|
| | | | concentration | Integrated | |
| | | | of | irradiation | Optical |
| | | | printed | dose needed | density |
| | A ink | B ink | matter | for curing | (OD |
| | type | type | (wt %) | (mJ/cm²) | value) |
| Working | black 1 | black 2 | 6.0 | 10,800 | 2.5 |
| Example 1 | | | | | |
| Working | black 2 | black 3 | 7.5 | 14,000 | 2.5 |
| Example 2 | | | | | |
| Comp. | black 1 | — | 3.0 | 10,800 | 1.8 |
| Example 1 | | | | | |

As shown in Table 1, it was confirmed in Working Examples 1 and 2 that the light blocking property was sufficient, and the products had performance that satisfied all the requirements as an optical element for a projector.

### Black Ink Compositions 4 to 6

Black ink compositions 4 to 6 was prepared from the following components by the same operation as for Black ink composition 1.

TABLE 2

| | Black ink | Black ink | Black ink |
|---|---|---|---|
| | composition 4 | composition 5 | composition 6 |
| Pigment black 7 | 3.0 | 9.0 | 6.0 |
| N-518 | 1.0 | 3.0 | 2.0 |
| N-vinylformamide | 25.0 | 25.0 | 25.0 |
| AG | 40.6 | 37.6 | 39.6 |
| Viscoat #1000 | 20.0 | 15.0 | 17.0 |
| Irgacure 819 | 6.4 | 6.4 | 6.4 |
| Irgacure 369 | 1.6 | 1.6 | 1.6 |
| BYK-3500 | 0.2 | 0.2 | 0.2 |
| Darocur EDB | 1.0 | 1.0 | 1.0 |
| Kayacure DETX-S | 1.0 | 1.0 | 1.0 |
| Irgastab UV-10 | 0.2 | 0.2 | 0.2 |

A two-constituent photo curable ink set equipped with the above-mentioned black ink compositions 4 and 5 (Working Example 4), a two-constituent photo curable ink set equipped with the above-mentioned black ink compositions 5 and 6 (Working Example 5), and a two-constituent photo curable ink set equipped with just the black ink composition 6 (Working Example 6) were used to form a light blocking film pattern in the same manner as above. Evaluation results are given in Table 3.

As shown in Table 3, it was confirmed in Working Examples 4 to 6 that the light blocking property was sufficient, and the products had performance that satisfied all the requirements as an optical element for a projector.

TABLE 3

| | | | Ink | | |
|---|---|---|---|---|---|
| | | | concentration | Integrated | |
| | | | of | irradiation | Optical |
| | | | printed | dose needed | density |
| | A ink | B ink | matter | for curing | (OD |
| | type | type | (wt %) | (mJ/cm²) | value) |
| Working | black 4 | black 5 | 6.0 | 8640 | 2.5 |
| Example 4 | | | | | |
| Working | black 5 | black 6 | 7.5 | 11,100 | 2.5 |
| Example 5 | | | | | |
| Working | black 6 | — | 6.0 | 8640 | 2.4 |
| Example 6 | | | | | |

1. A two-constituent photo curable ink set, comprising:
an ink composition A that includes a pigment and a polymerizable compound; and an ink composition B that includes a pigment and a polymerizable compound, wherein
the ink composition A and the ink composition B are mixed and then photo curing by being irradiated with light or ultraviolet ray.

2. The two-constituent photo curable ink set according to claim 1, wherein pigment concentration Ca in the ink composition A and pigment concentration Cb in the ink composition B satisfy the relation Ca<Cb.

3. The two-constituent photo curable ink set according to claim 1, wherein the ink composition A and/or the ink composition B includes at least one type of optical radical polymerization initiator.

4. The two-constituent photo curable ink set according to claim 3, wherein the optical radical polymerization initiator is one or more of aminoketone, hydroxyketone, and acylphosphine oxide.

5. The two-constituent photo curable ink set according to claim 1, wherein the ink composition A and/or the ink composition B includes ethylene glycol monoallyl ether and/or N vinylformamide as a polymerizable compound.

6. The two-constituent photo curable ink set according to claim 1, wherein the ink composition A and/or the ink composition B includes at least one type of dendritic polymer as a polymerizable compound.

7. The two-constituent photo curable ink set according to claim 6, wherein the dendritic polymer is a hyperbranched polymer.

8. The two-constituent photo curable ink set according to claim 1, wherein the ink composition A and/or the ink composition B includes at least one type of surfactant.

9. The two-constituent photo curable ink set according to claim 8, wherein the surfactant is a polyether-modified polydimethylsiloxane or a polyester-modified polydimethylsiloxane.

10. The two-constituent photo curable ink set according to claim 1, wherein the ink composition A and/or the ink composition B includes at least one type of amine-based polymerization accelerator.

11. The two-constituent photo curable ink set according to claim 1, wherein the ink composition A and/or the ink composition B includes at least one type of HALS-based radical polymerization inhibitor.

12. The two-constituent photo curable ink set according to claim 1, wherein the ink composition A and/or the ink composition B includes at least one type of thioxanthone-based sensitizer.

13. The two-constituent photo curable ink set according to claim 1, wherein the ink composition A and/or the ink composition B includes a black pigment as a pigment.

14. The two-constituent photo curable ink set according to claim 13, wherein the black pigment is carbon black.

15. The two-constituent photo curable ink set according to claim 1, wherein neither the ink composition A nor the ink composition B includes a volatile component.

16. A method for manufacturing an optical element, comprising:
producing an optical element by inkjet process using the two-constituent photo curable ink set according to claim 1.

17. A method for manufacturing an optical element, comprising:
producing an optical element by screen printing, flexographic printing, or pad printing using the two-constituent photo curable ink set according to claim 1.

18. A method for manufacturing an optical element, comprising:
forming a light-blocking film pattern by inkjet process using the two-constituent photo curable ink set according to claim 1, and then conducting a curing reaction by irradiation with ultraviolet rays.

19. The method for manufacturing an optical element according to claim 18, wherein the irradiation with ultraviolet rays is performed using an LED and/or LD as an ultraviolet ray source.

20. The method for manufacturing an optical element according to claim 18, wherein the irradiation with ultraviolet rays is performed using an LED array formed of a plurality of semiconductor elements having different wavelength peaks.

21. An optical element, manufactured by the manufacturing method according to claim 16.

22. An optical element for a projector, manufactured by the manufacturing method according to claim 16.
